(19) United States
(12) Patent Application Publication
(10) Pub. No.: US 2013/0100989 A1
(43) Pub. Date: Apr. 25, 2013

(54) Multi-functional weather alert communication key chain

(71) Applicants: Clarence Copeland, Clarkston, GA (US); Aaron Gardner, Atlanta, GA (US)

(72) Inventors: Clarence Copeland, Clarkston, GA (US); Aaron Gardner, Atlanta, GA (US)

(73) Assignee: Clarence Copeland, Clarkston, GA (US)

(21) Appl. No.: 13/507,197

(22) Filed: Jun. 12, 2012

Related U.S. Application Data
(60) Provisional application No. 61/628,203, filed on Oct. 25, 2011.

(51) Int. Cl. H04B 1/38; H04R 3/00; H04R 23/00; G08B 6/00; G08B 5/00

(52) U.S. Cl. CPC H04B 1/3833; G08B 6/00; G08B 5/00; H04R 23/00; H04R 3/00
USPC 375/219; 340/407.1; 381/150; 381/122; 340/815.4

(57) ABSTRACT

The present invention encompasses a key chain device which receives disaster and/or radio broadcast worldwide. The digital component scans for and receives, the strongest broadcast signal, within the vicinity of the user and/or where disaster is occurring. Comprised of both digital & analog receivers and transmitters, the device can furthermore be used to communicate with and control analog and digital devices. This programmable feature enables the device to perform such functions as remotely controlling car starting/alarms, garage doors, and house alarms, etc. Enabling the internal microprocessor, said device can serve to entertain users with the digital media player, keeping them connected with a GPS locater. Additionally, the present invention has a cellular telephone component, with the ability to pair with wireless Bluetooth devices. This invention is a novel use of components, providing users with an enhanced level of control, convenience, electronic device connectivity and interaction in their daily life.

### CROSS-REFERENCE TO RELATED APPLICATIONS

This application for the present invention claims priority from Provisional U.S. patent application No. U.S. 61/628,203, filed on Oct. 25, 2011 and cross-references U.S. patent application No. 29/374,676, filed on Sep. 20, 2011.

### STATEMENT REGARDING FEDERALLY SPONSORED RESEARCH OR DEVELOPMENT

This invention was made without Government support. The inventor retains all rights to this invention.

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates to small communication devices with microprocessors that are carried by users and function as Personal Digital Assistants (PDA) in performing such tasks as, cellular communication, activating and deactivating radio controlled mechanisms such as car & garage doors, displaying and playing digital media, and more particularly, is directed toward electronic devices in constant communication with National Weather Alert broadcast frequencies and which are GPS enabled.

### BACKGROUND/DISCUSSION OF RELATED ART

It is an object of the current invention to provide the end user with a keychain sized PDA (Personal Digital Assistant) device that can display weather updates and give early warning in cases of catastrophes, giving the end user time to respond. The current invention uses various means of receiving and displaying National Alert Signals and which emits loud audible tones, alerting such user. Furthermore, the current invention is comprised of a microprocessor, display screen and digital communication elements, the size of which allows the invention and it's components to fit on a small key chain. The invention can also be detached from the key ring and fit comfortably in one's pocket. The unit will allow adjustment of sound, and visual elements, to enhance the hearing of alerts and screen visibility. Technology within the current invention that is comprised of, but is not limited to, digital and analog signal receiving & transmission, remotely controlled radio devices, automatic frequency tuning, can be found in U.S. Patent Applications; Pub. No.: US 2003/0054804 A1, Pub. No.: US 2004/0071471 A1, Pub. No.: US 2005/0143152 A1, Pub. No.: US 2008/0129885 A1, Pub. No.: US 2008/0129885 A1, Pub. No.: US 2009/0063911 A1, Pub. No.: US 2009/0262253 A1, Pub. No.: US 2008/0248838 A1, Pub. No.: US 2010/0304702 A1. As well as; U.S. Pat. No. 5,148,159, U.S. Pat. No. 4,461,002, U.S. Pat. No. 5,528,230, U.S. Pat. No. 6,463,469 B1, U.S. Pat. No. 6,791,468 B2, U.S. Pat. No. 7,149,488 B2, U.S. Pat. No. 7,469,137 B2, and U.S. Pat. No. 7,965,204 B2.

In light of the foregoing discussion, the multitude of electronic devices which individuals own and utilize on a daily basis presents a need to simplify the electronic communication process with a device that can send and receive both analog and digital signals keeping end user's in constant communication in the event of an emergency.

### BRIEF DESCRIPTION OF DRAWINGS

FIG. 1 is a perspective view of the front display side of the current invention with a detachable key ring,

FIG. 2. is a perspective view of the rear side of current invention with USB port retracted.

FIG. 3. is a perspective view of the rear side of current invention with USB port extended.

FIG. 4 is a profile view of the base of the front display side of the current invention.

FIG. 5 is a right profile view of the front display side of the current invention.

FIG. 6 is the front display profile view of the current invention

FIG. 7 is the rear side profile view of the current invention.

FIG. 8 is the profile view of the rear side of the current invention.

FIG. 9 is the top profile view of the rear side of the current invention.

FIG. 10 is a block diagram, outlining the various internal and external elements and modules comprised within the current invention.

### DETAILED DESCRIPTION OF THE INVENTION AND THE PREFERRED EMBODIMENT

It will be readily understood that the components of the present invention, as generally described and illustrated in the Figures herein, may be arranged and designed in a wide variety of different configurations. Thus, the following more detailed description of embodiments of the present invention, as represented in the Figures is not intended to limit the scope of the invention, as claimed, but is merely representative of a selected embodiment of the invention. The illustrated embodiment of the invention will best be understood by reference to the drawings, wherein like parts are designated by like numerals throughout. Those of ordinary skill in the art will, of course, appreciate that various modifications to the methods described herein may easily be made without departing from the essential characteristics of the invention, as described in connection with the Figures. Thus, the following description of the Figures is intended only by way of example, and simply illustrates a certain selected embodiment consistent with the invention as claimed herein

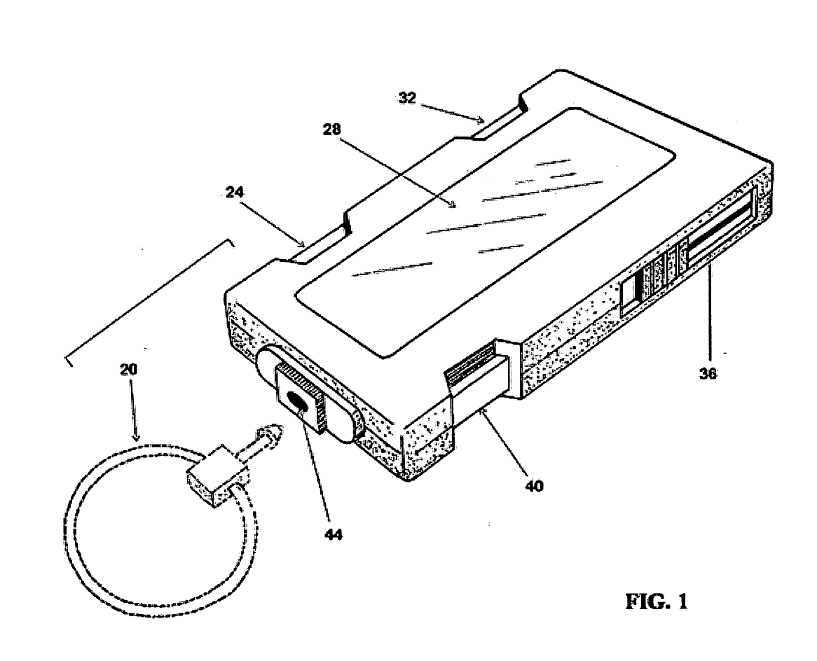

Referring now to the invention in more detail, FIG. 1 shows a perspective view of the front with 20) Detachable Key ring, 24) Control Button 1, 28) Display Screen, 32) Button to activate light element, 36) Indention to hold USB slide handle, 38) the USB slide handle, 40) Control Button 2, 44) Anchor to secure and release detachable key ring.

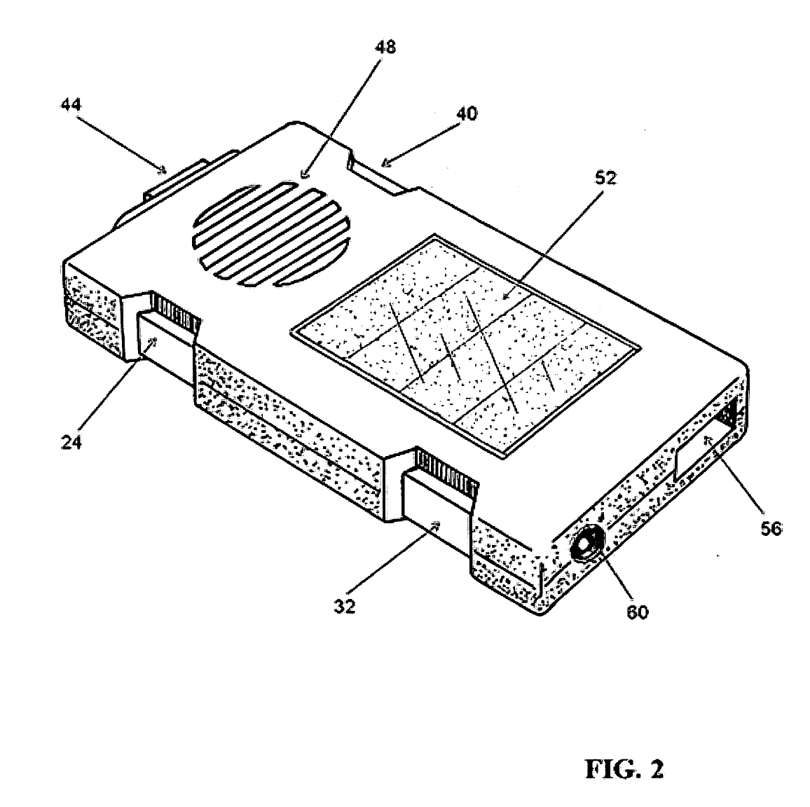

Referring now to FIG. 2, there is shown a perspective view of the rear with 24) Control Button 1, 32) Button to activate light element, 40) Control Button 2, 44) Anchor to secure and release detachable key ring, 48) Perforated section to allow sound from speaker, 52) Solar Panel, 56) USB port, USB retracted, 60) Light Element.

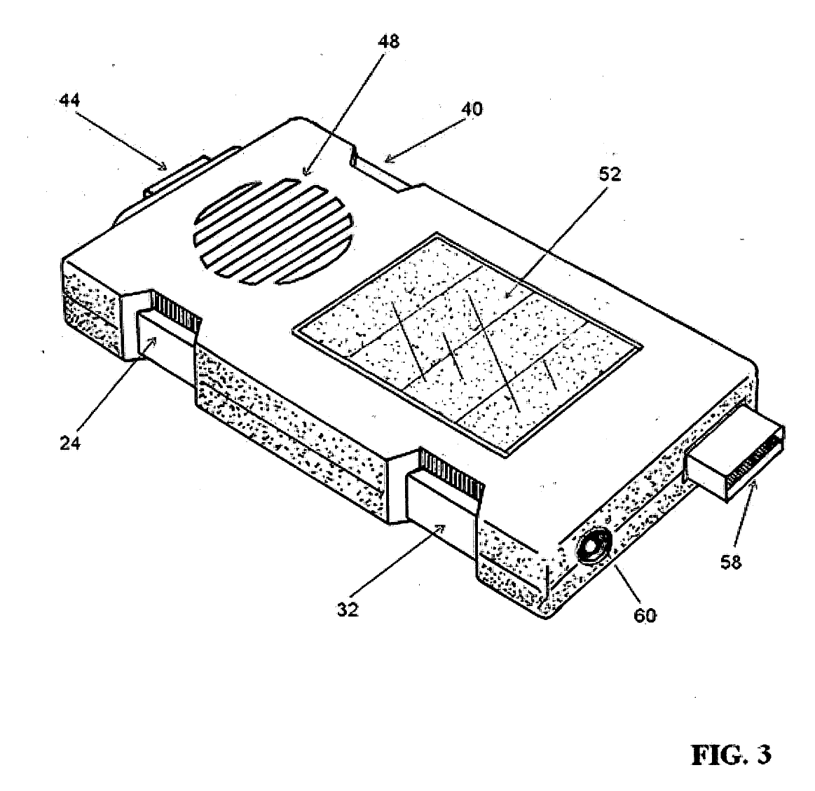

In further detail, FIG. 3, there is shown a perspective view of the rear with the 58) USB port extended, 24) Control button 1, 32) Button to activate light element, 40) Control Button 2, 44) Anchor to secure and release detachable key ring, 48) Perforated section to allow sound from speaker, 52) Solar Panel, 60) Light Element.

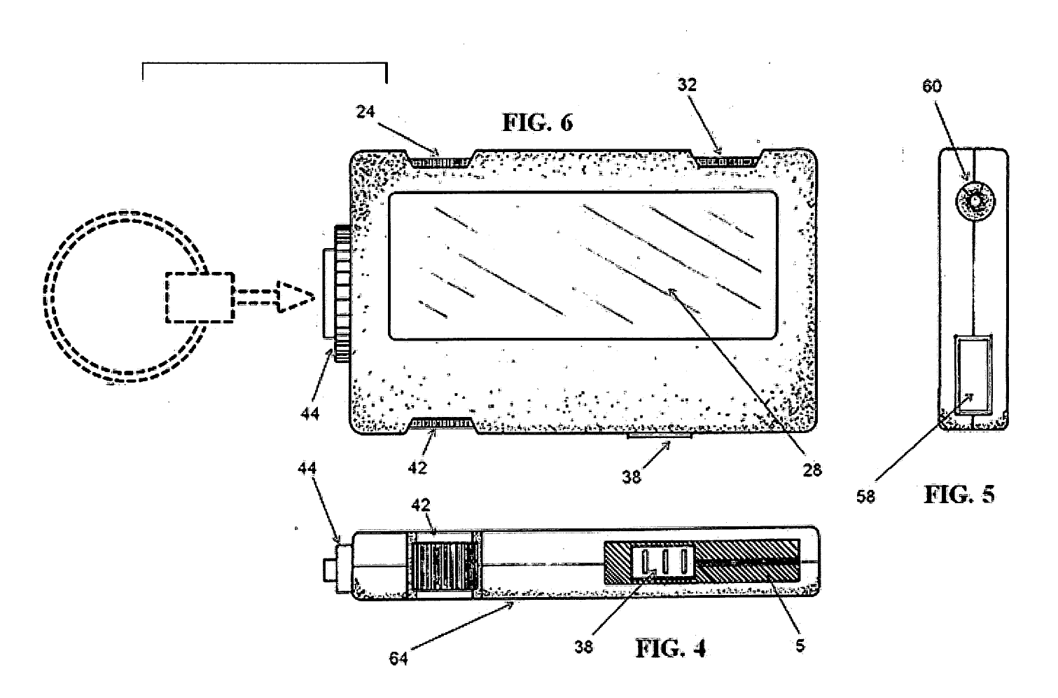

Referring now to FIG. 4, there is shown a shows the bottom view of the display shown in FIG. 1, with the 36) Indention to hold the USB slide handle, 38) the USB slide handle, 40) control button 2, 44) Anchor to secure and release detachable key ring and 64) Outer Casing.

Referring now to FIG. 5, there is shown a right view of the display showing the 60) Light Element and the 58) USB port retracted.

Referring now to FIG. 6, there is shown a front view of the device, with the 20) Detachable Key ring, 24) Control Button 1, 28) Display Screen, 32) Button to activate light element, 38) USB slide handle and 40) Control Button 2 with 44) Anchor to secure and release detachable key ring.

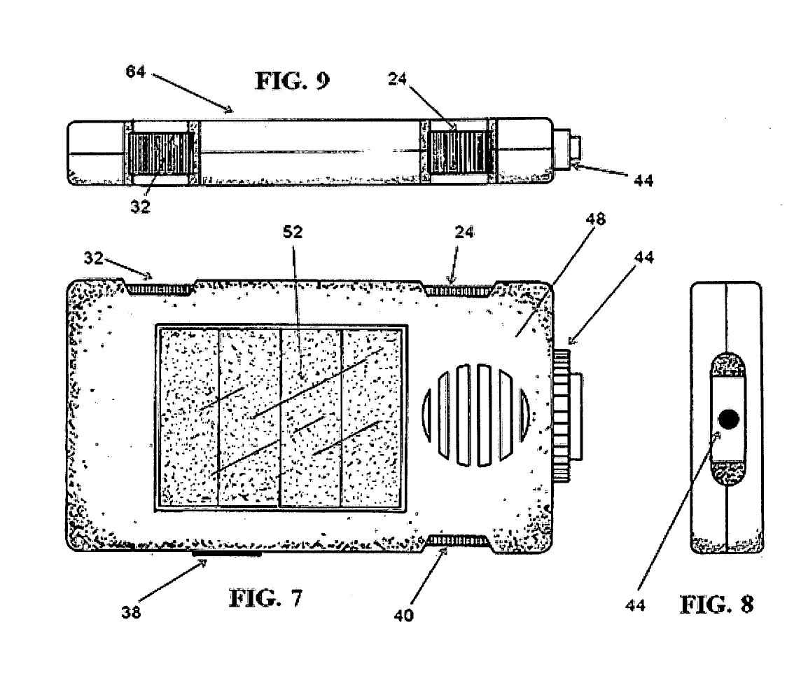

Referring now to FIG. 7, there is shown a rear view of the device showing 24) control button 1, 32) Button to activate the light element, the 38) USB slide handle, 40) Control button 2, 44) Anchor to secure and release detachable key ring, 48) Perforated section to allow sound from speaker, and 52) Solar panel.

Referring now to FIG. 8, there is shown a right view of the device from a rear perspective with the 44) Anchor to secure and release detachable key ring.

Referring now to FIG. 9, there is shown a top view of the device from a rear perspective, with the 32) Button to activate the light element, 24) Control button 1, 44) Anchor to secure and release detachable key ring, and the 64) Outer casing.

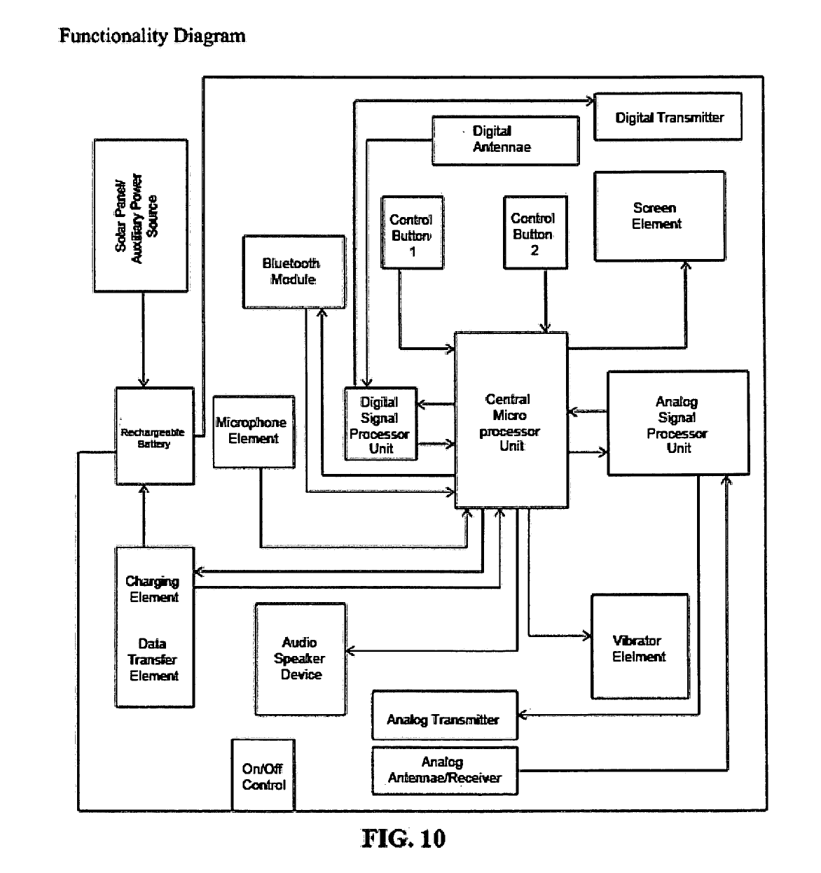

Referring now to the invention in more detail, FIG. 10 shows the internal functionality of the comprised elements and modules, represented in a block diagram. The internal components are comprised of; Solar Panel/Auxiliary Power Source, Digital Antennae, Digital Transmitter, Bluetooth Module, Rechargeable Battery, Microphone Element, Digital Signal Processor Unit, Central Micro Processor Unit, Analog Signal Processor Unit, Charging Element Data Transfer Element, Audio Speaker Device, Vibrator Element, Analog Transmitter and an Analog Antennae/Receiver. The aforementioned elements and modules combined allow the user to carry on them, a miniature device capable of controlling analog and digital devices, in addition to receiving data message and cellular transmissions.

The construction details of the invention as shown in FIGS. 1-9 are that the Multi-Functional Weather Alert Communication Key Chain may be made have an internal circuit board comprised of the elements and modules represented in FIG. 10. The outer casing can be made of a sufficiently rigid and strong material such as high-strength plastic, metal, and the like. Further, the various components of the Multi-Functional Weather Alert Communication Key Chain can be made of different materials.

The advantages of the present invention include, without limitation, that it combines commonly used electronic devices in a miniature form, adding to the end user's convenience and electronic data connectivity. In broad embodiment, the present invention is a GPS enabled keychain sized PDA (Personal Digital Assistant) device that can send a receive analog and digital signals, including cellular phone signals, display weather updates and give early warning in cases of catastrophes, giving the end user time to respond.

The invention should therefore not be limited by the above described embodiment, method, and examples, but by all embodiments and methods within the scope and spirit of the invention as claimed.

### METHODS OF USE

Because the current invention is a miniature version and combination of commonly used electronic communication devices, the specific use and connectivity level is determined by the user. Receiving both digital and analog frequencies, the device can be used to access the internet wirelessly and furthermore be used as a Personal Digital Assistant and/or electronic organizer.

With the current inventions analog transmitter function, a user's VIN # and other data pertaining to secure motor vehicle operation, can be programmed into the device, in order to activate an electronic key to remote start the car, open doors, lock doors, open trunk, turn on the lights etc.

Furthermore, with the current inventions analog transmitter function, a user can activate and deactivate programmable receivers within the user's home to open doors including garage door, turn lights on and off; arm/disarm home security. In the capacity of a radio frequency receiver, the current invention can receive alert signals from said home security device(s).

Functioning in the mode of a cellular phone, the current invention communicates with the user via a bluetooth device and/or internal speaker and microphone.

As a receiver and alert responder the current invention will automatically sound off a national and/or regional alert broadcast, in the event of terrorist attack, tornado, flood or other natural disasters in the area or region. Furthermore, Presidential and local Amber Alert messages can be displayed on the device screen.

Being an electronic message receiving device, the current invention is an ideal means of promotional and informational communication in hotel establishments, whereby patrons can be contacted anywhere on site. Upon hotel registration, signals from the front desks main computer can be sent to the current invention, notifying users of special promotions, recreational facility availability and location, dinner reservations, dinner menu, patron call-in reservations, hotel emergencies, room upgrades, charter bus pickup, close out time, bill amount.

The current invention can be supplied by car dealerships to promote the dealership and provide service notifications to car owners. Not only is the device capable of activating/deactivating the car alarm, locking/unlocking doors and trunk, but also the device can be a tool used by dealers to enhance customer service by informing car owners of specials on tires, cars, in addition to receiving reminders of scheduled maintenance such as oil and filter changes.

Additionally, the current invention can be a method of communication between the end users (consumers) and entities such as Insurance Companies, Corporations in order to providers in various service industries.

What is claimed is:

1. A Multi-functional Weather Alert Communication Key Chain assembly, comprising: a deployable ergonomic housing adapted to be transported by end user, said housing comprising one half, with indentations to accommodate a screen display element, a second bottom half, with indentations to accommodate a solar panel auxiliary power source with spacing between both halves accommodating tactile functional control elements or buttons, which further control the power on/off means, with an external portion of the device thereof adapted to be coupled to a removable keychain eyelet, said device furthermore comprising a central microprocessor unit, an analog signal processor means, a digital signal processor means, a hardline charging/data transfer connection port, an internal rechargeable battery or power supply means, a Bluetooth™ or wireless data transfer connection module, a motorized vibrational element within said housing, an internal analog or digital signal antennae, an internal analog or digital signal transmitter, a speaker element disposed within said housing, a microphone element, a light emitting means projecting from said housing, whereby said Multi-functional Weather Alert Communication Key Chain can be operated by an end user.

2. The solar panel in claim 1, exposed on the bottom surface of the present invention comprising, a photovoltaic cell, connected to an internal rechargeable power supply means within the current invention.

3. The screen display element in claim 1 exposed on the surface of the present invention, comprising a capacitive touch screen, capable of displaying images and receiving touch screen input from the end user, furthermore comprising the capability to display:
(a) multi media images,
(b) interactive icons,
(c) functional controls.

4. Tactile functional control elements or buttons, as in claim 1, comprising a means of controlling electronic operations within the current invention.

5. The central microprocessor in claim 1, comprising configurations enabling the control of electronic functions within the present invention, wherein said configurations further enable:
a) the present invention to be used as a personal data assistant, a cellular phone, a global positioning system device, thus performing functions related to the use of such devices,
b) the ability to process external data programming, thereby allowing externally stored software to be executed in programming upgrades, of the present invention,
c) the present invention to digitally seek radio frequencies reserved for the National Weather Alert broadcast frequencies,

6. An internal antennae within the present invention, comprising a means of receiving analog or digital frequency signals, whereby said internal antennae is configured to the central microprocessor of claim 5.

7. An internal transmitter within the present invention comprising a means of transmitting analog or digital frequency signals, whereby said internal transmitter is configured to the central microprocessor of claim 5.

8. A hardline charging/data transfer connection port, further comprising:
(a) a digital data transfer means,
(b) a means of transferring power to an internal power supply means as in claim

9. An internal power supply means, further comprising a battery capable of being charged by the solar panel of claim 2 or the hardline charging/data transfer connection port of claim 11.

10. A wireless data transfer connection module, comprising a means of electronic communication with said central microprocessor of claim 1, enabling the receiving or transmitting of digital data or voice signals, whereby said wireless data transfer connection module establishes a wireless connection to an external device having a compatible wireless data transfer connection element.

11. An internal motorized vibrational element within the current invention comprising a vibrating means, whereby a vibrating signal from said element vibrates the entire Multi-functional Weather Alert Communication Key Chain assembly, thereby silently calling attention to the user.

12. A speaker element disposed within said housing, comprising a means of producing audible alerts, or sounds to be heard by the user.

13. A microphone element disposed within said housing, comprising a means of receiving audio input.

14. A light emitting means as in claim 1, projecting from said housing of the present invention comprising a means of illuminating an external region, outside of said housing.
